(19) United States
(12) Patent Application Publication
(10) Pub. No.: US 2024/0074016 A1
(43) Pub. Date: Feb. 29, 2024

(54) VOLTAGE-EQUALIZING POWER DISTRIBUTION TYPE STRIP LIGHT AND WIRING METHOD THEREOF

(71) Applicant: SMART ELECTRIC WORKS CO., LTD., Chang Hua Hsien (TW)

(72) Inventor: JERRY YANG, Taichung (TW)

(21) Appl. No.: 18/221,789

(22) Filed: Jul. 13, 2023

(30) Foreign Application Priority Data
Aug. 30, 2022 (TW) 111132656

(51) Int. Cl. H05B 45/46

(52) U.S. Cl. CPC H05B 45/46

(57) ABSTRACT

The invention discloses a voltage-equalizing power distribution type strip light and a wiring method thereof, which uses the circuit layout design on a strip light to extend one power supply line of the power supply end of the strip light to supply power from the rear end of the strip light, forming a structure that supplies power from both ends of the strip light. The present invention also uses a connector so that after the strip light is cut to any length, the power supply can still be connected to the rear end of the strip light to meet various length requirements.

### BACKGROUND OF THE INVENTION

### (a) Field of the Invention

The present invention relates to the technical field of strip lights, in particular to a voltage-equalizing power distribution type strip light and a wiring method thereof, which enables the power supply voltage of each light-emitting element from the head end to the tail end of the strip light to be made more equal, so that the whole strip light maintains a more uniform brightness effect.

### (b) Description of the Prior Art

The popular LED strip light in recent years is a lighting decoration with multiple LED components installed on a flexible strip substrate. It is not easy to generate heat and is not limited by space and use, so it is widely used as lighting or lighting decoration for commercial, residential, garden, building appearance, etc. General LED characteristics are very suitable for constant current drive. However, because the length of the LED strip light is very diverse, it is not suitable to be driven by a constant current method as a whole, and there is also the problem of high cost if each LED element or each group of LED components is driven by a constant current, so a constant voltage power supply is generally used. Commonly seen LED strip lights match the power supply voltage on the strip substrate, and three LED components and a current limiting resistor are connected in series to form an LED set. Each LED set is connected in parallel to the power path extended from the aforementioned DC power supply. Users can also cut according to the actual length, with one LED set as the unit. The LED components on the strip light can be white LED components or RGB color LED components according to the purpose, and the power supply is controlled by an external control box to achieve functions such as blinking, dimming, color changing or flickering.

However, when the length of the conventional LED strip light is relatively long, because the line impedance on the LED strip light will increase with the length of the strip light, the voltage drop at the tail end of the strip light will be larger, so that the brightness of the whole strip light will appear that the LED components at the head end are relatively bright, and the brightness at the tail end has obvious brightness unevenness that becomes darker. Referring to FIG. 1, the circuit diagram for analyzing and explaining the uneven brightness of the conventional LED strip light, that can help reduce the uneven brightness of the head and taillights of the conventional LED strip light. In the figure, for example, three 9V LED components are connected in series with a 5-ohm current-limiting resistor, each of which is placed at 0 meters, 5 meters, and 10 meters away from the power supply terminal. The total length of the strip light is 10M, powered by DC12V. The wire adopts AWG #22 standard wire, and its copper impedance is 0.052 ohms per meter according to the American Wire Gauge AWG standard, and the line impedance of every 5 meters long wire is 0.052×5=0.26 ohms. At the same time, to simplify the calculation, it is assumed that the forward voltage across the LED component is fixed at an ideal value of 9V (the actual LED forward voltage will vary slightly with its forward current). The circuit and related numerical values are shown in FIG. 1. This circuit forms three loops. We can use the voltage law to list the voltage equations of each loop and solve for the current flowing through each LED component, as follows:

Loop 1:5*I1+9V=12V→I1=0.6A 1-\textcircled{1}

Loop 2:5*I1+9V=0.52*(I2+I3)+5*I2+9V→5*I1=5.52*I2+0.52*I3bring in I1=0.6A→I2=0.544-0.094*I3 1-\textcircled{2}.

Loop 3:5*I2+9V=5.52*I3+9V→I2=1.33*I3 1-\textcircled{3}.

Solving the 1-\textcircled{2} and 1-\textcircled{3} equations gives I2=0.508 A, I3=0.382 A, and I1=0.6 A

The result of the solution shows that the current I1 of the LED component connected to the power supply end is 0.6 A, and the current I2 of the LED component connected to the middle 5 meters is reduced to 0.508 A, accounting for 84.7% of the current of the LED component at the power supply end, and the current I3 of the LED component connected to the end at 10 meters is even lowered to 0.382 A, which only accounts for 63.7% of the current of the LED component at the power supply end, and the brightness of the LED component is proportional to the forward current flowing through it. It can be seen that as the voltage drop toward the tail end of the strip light increases, the current flowing through the LED component at the tail end becomes smaller. The brightness of the entire strip light will appear that the brightness of the LED components at the head end is relatively bright, while the brightness at the tail end becomes darker and uneven, which seriously affects the appearance of the strip light.

### SUMMARY OF THE INVENTION

As mentioned above, in the conventional LED strip light, due to the wire impedance relationship, when the strip light is relatively long, the voltage drop becomes larger as the strip light gets closer to the tail end, so that the current flowing through the LED components at the tail end is smaller, and the brightness of the entire strip light appears to be uneven in the brightness of the LED components at both ends. The “voltage-equalizing power distribution type strip light and a wiring method thereof” of the present invention is to provide a simple, novel and unique solution, which uses a detour line to extend one of the power lines at the power supply end of the LED strip light to supply power from the tail end, forming a structure that supplies power from both ends of the strip light, which can eliminate the problem that the voltage drop of the strip light increases as it goes to the tail end of the strip light due to the line impedance, so that the power supply voltage of each LED component from the head end to the tail end of the strip light is more balanced, thereby achieving the effect of maintaining a more uniform brightness of the entire strip light from the head end to the tail end.

For the working principle of the present invention, please refer to FIG. 2 “schematic diagram of the wiring Method for strip lights of the voltage-equalizing power distribution type of the present invention”. The circuit and LED component parameters in the figure are the same as those in FIG. 1 “analysis and explanation circuit diagram of conventional LED strip light brightness unevenness”. Just extend one of the power lines to the tail end of the strip light for power supply. The total length of the strip light is also 10M. Also, three 9V LED components are connected in series with a 5 ohm current-limiting resistor, which are also placed at 0 meters, 5 meters, and 10 meters from the power supply terminal. They are also powered by DC 12V, and the wires are also AWG #22. gauge wire, its copper impedance is 0.052 ohms per meter according to the American Wire Gauge AWG standard, and the line impedance of each 5-meter-long wire is 0.052×5=0.26 ohms. At the same time, to simplify the calculation, it is also assumed that the forward voltage across the LED component is fixed at an ideal value of 9V (the actual LED forward voltage will vary slightly with its forward current). We changed the extension of the power line at the lower end to be powered by the tail end. The circuit and related numerical values are marked in FIG. 2, and the circuit also forms a total of three loops. We can also use the voltage law to list the voltage equations of each loop and solve the current flowing through each LED component, as follows:

Loop1:12=9+(5+0.26)*I1+0.26*(I1+I2)+0.52*(I1+I2+I3)→6.04*I1+0.78*I2+0.52*I3=3 2-\textcircled{1}.

Loop2:9+5.26*I1=9+0.26*(I2+I3)+5*I2→5.26*I1-5.26*I2-0.26*I3=0 2-\textcircled{2}

Loop3:9+5*I2+0.26*(I1+I2)=(0.26+5)*I3+9→0.26*I1+5.26*I2=5.26*I3 2\textcircled{3}

Solving the above 2-\textcircled{1}, 2-\textcircled{2}, 2-\textcircled{3}simultaneous equations gets I1=0.411 A, I2=0.395 A, and I3=0.411 A.

The results show that the current I1 of the LED component connected to the head of the strip light is 0.411 A, while the current I2 of the LED component connected at the middle 5 meters is 0.395 A, accounting for 96.1% of the current of the LED component at the head, which is very close to the current of the LED component at the head, and the current I3 of the LED component connected at the end of 10 meters is 0.411 A, which is 100% the same as the current value of the LED component at the head of the strip light. The brightness of the LED component is proportional to the forward current flowing through it. Although the current of the LED component at the middle 5 meters is a little smaller, the difference is very small. Through practical observation, there is no phenomenon of uneven brightness at all, which effectively improves the problem of uneven brightness at the head and tail of the strip and achieves the innovative goal of achieving a uniformly bright strip light at low cost.

### BRIEF DESCRIPTION OF THE DRAWINGS

FIG. 1 is a circuit diagram for analyzing and explaining uneven brightness of a conventional LED strip light.

FIG. 2 is a schematic diagram of the strip light wiring method of the voltage equalization distribution type of the present invention.

FIG. 3 is a schematic diagram of an embodiment of the voltage-equalizing power distribution type strip light of the present invention.

FIG. 4 is a schematic diagram of the second embodiment of the voltage-equalizing power distribution type strip light of the present invention.

FIG. 5 is a schematic diagram of an embodiment of the double-layer circuit board wiring on the front layer and back layer of the white light LED strip light of the present invention.

FIG. 6 is a schematic diagram of an embodiment of the wiring of the front layer and the back layer of the self-connected end of the double-layer circuit board of the white light LED strip light of the present invention.

FIG. 7 is a schematic diagram of an embodiment of the wiring on the front layer and the back layer of the double-layer circuit board of the RGB color LED strip light of the present invention.

FIG. 8 is a schematic diagram of an embodiment of the wiring of the front layer and the back layer of the self-connected end of the double-layer circuit board of the RGB color LED strip light of the present invention.

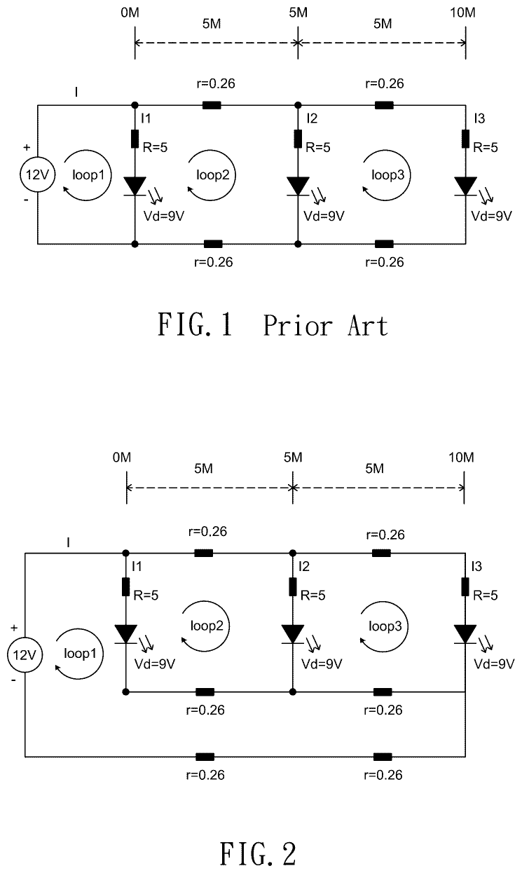

### DETAILED DESCRIPTION OF THE PREFERRED EMBODIMENTS

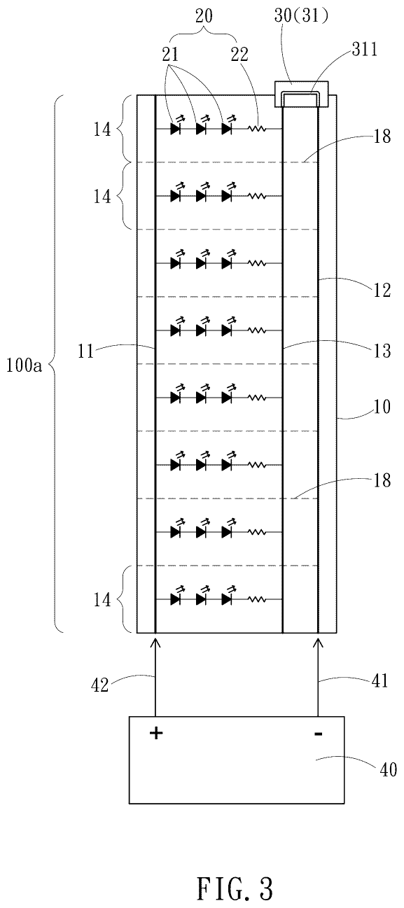

Referring to FIG. 3, a kind of voltage-equalizing power distribution type strip light and wiring method thereof of the present invention, a preferred embodiment of the voltage-equalizing power distribution type strip light comprises a strip light circuit board 10, a plurality of LED units 20, a connector 30 and a driving device 40.

The strip light circuit board 10 is implemented as a long-printed circuit board structure that can be cut to any length and can be a hard circuit board or a flexible circuit board. A first circuit 11, a second circuit 12 and a detour circuit 13 are implemented on the strip light circuit board 10. The first circuit 11, the second circuit 12 and the detour circuit 13 are all printed circuits, which can be arbitrarily implemented on the front or back of the single-layer circuit board of the strip light circuit board 10 and extend all the way from the front end of the strip light circuit board 10 to the rear end.

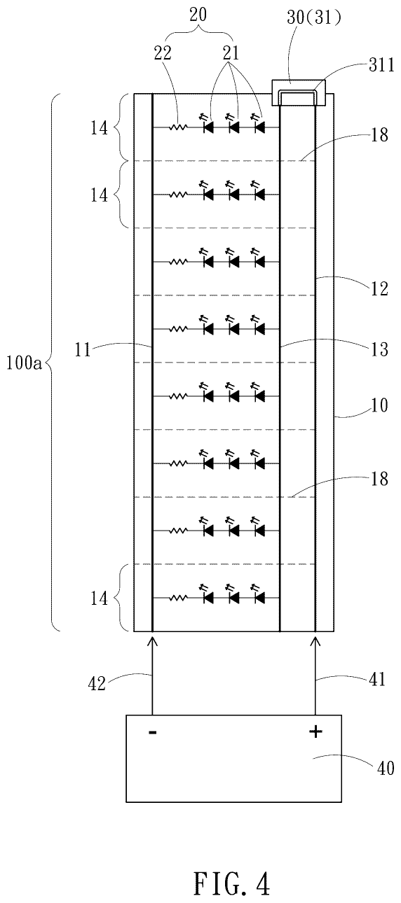

The LED units 20 are connected in parallel between the first circuit 11 and the detour circuit 13. Each LED unit 20 can be composed of one or more LED components 21 connected in series and a current limiting resistor 22 connected in series, for example, as shown in the figure, three LED components 21 and one current limiting resistor 22 are connected in series. Then connect the positive potential end of each LED unit 20 to the first circuit 11 and connect the negative potential end of each LED unit 20 to the detour circuit 13. Conversely, as shown in FIG. 4, the negative potential end of each LED unit 20 can also be connected to the first circuit 11 and the positive potential end of each LED unit 20 can be connected to the detour circuit 13. The present invention uses the circuit layout of the strip light circuit board 10 and LED units 20 to form a strip light unit 100a of appropriate length, which can be cut into a shorter length for use, or multiple strip light units 100a can be connected to form a longer use length.

The connector 30 (or jumper) is a device used to connect the second circuit 12 and the detour circuit 13 at the rear end of the strip light unit 100a (strip light circuit board 10), and it can be a plug-in connector 31. The plug-in connector 31 has a plug conductor 311 (such as a plug terminal) inside. When it is combined at the rear end of the strip light circuit board 10, the plug conductor 311 is connected between the second circuit 12 and the detour circuit 13 extending to the rear end of the strip light circuit board 10. The connector 30 can also be any other welded conductor, which is connected between the second circuit 12 and the detour circuit 13 extending to the rear end of the strip light circuit board 10 by welding.

The driving device 40 is an existing LED driver for supplying direct current, which is connected to the front end of the strip light unit 100a (strip light circuit board 10) through two connection lines 41, 42, wherein the negative potential of the driving device 40 is connected to the second circuit 12 at the front end of the strip light circuit board 10 through one connection line 41, and the positive potential of the driving device 40 is connected to the first circuit 11 at the front end of the strip light circuit board 10 through the other connection line 42. The LED unit 20 in FIG. 4 is opposite to the LED unit 20 shown in FIG. 3, so the positive potential of the driving device 40 is connected to the second circuit 12 at the front end of the strip light circuit board 10 through one connection line 41, and the negative potential of the driving device 40 is connected to the first circuit 11 at the front end of the strip light circuit board 10 through the other connection line 42.

According to the layout design of the layout design of the strip light circuit board 10 and multiple LED units 20 of the present invention shown in FIG. 3, the positive potential of the driving device 40 is connected to the first circuit 11 at the front end of the strip light circuit board 10, and the negative potential is extended to the rear end of the strip light circuit board 10 through the second circuit 12, and then connected to the detour circuit 13 through the connector 30 (the principle of FIG. 4 is the same as above). Therefore, the present invention changes one of the power supply extensions at the power supply end to supply power from the rear end of the strip light circuit board 10 through the detour circuit 13, forming a structure that supplies power from both ends of the strip light circuit board 10 to eliminate the problem of greater voltage drop towards the rear end due to line impedance. This makes the power supply voltage of each LED unit 20 of the LED strip light more uniform from the head end to the rear end and achieves the effect of maintaining a more uniform brightness of the entire strip light from the head end to the backend.

The above-mentioned strip light circuit board 10 of the present invention is implemented as a circuit layout that can be arbitrarily cut to its length, and the strip light circuit board 10 is implemented as a plurality of LED sets 14 connected in a row. The above-mentioned first circuit 11, second circuit 12 and detour circuit 13 extend from the front end of the strip light circuit board through each LED set 14 until the rear end of the strip light circuit board 10. Each LED set 14 can implement one or more than one LED unit 20 (the connection method is as described above), and each LED set 14 can be cut from a cutting point 18. Therefore, before use, the strip light circuit board 10 can be cut out according to specific use length requirements, so that the strip light circuit board 10 will have at least one or more LED sets 14, on which there are first circuit 11, second circuit 12, detour circuit 13 and LED unit 20. Then use the connector 30 to connect the second circuit 12 and the detour circuit 13 from the rear end, to simply form a method in which one line power supply of the driving device 40 is changed to be powered from the rear end of the strip light circuit board 10.

The following are examples of voltage-equalizing power distribution type white light LED strip light, voltage-equalizing wiring type RGB color LED strip light PCB layout and other embodiments in order, and are further explained as follows with the accompanying drawings:

[Embodiment of Voltage-Equalizing Power Distribution Type White Light Strip Light]

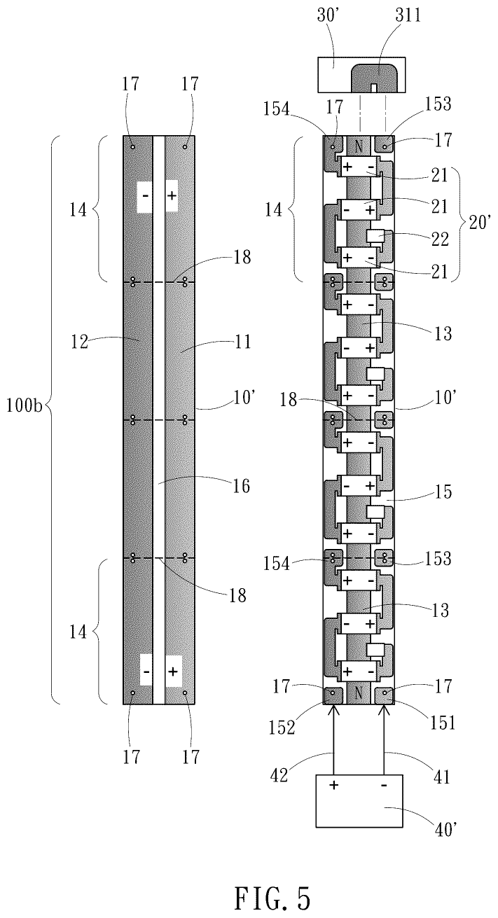

Referring to FIG. 5, it is a schematic diagram of a white light LED strip light circuit board wiring embodiment of a voltage-equalizing power distribution type strip light of the present invention. In this embodiment, the above-mentioned strip light circuit board 10 is described as an example of a double-layer circuit board 10′ (but the present invention is not limited to the number of layers of the circuit board). The double-layer circuit board 10′ is also implemented as a strip printed circuit board structure, and the front layer 15 and the back layer 16 both adopt a top view angle.

In this embodiment, the driving device 40′ provides DC power and is connected to two contacts 151, 152 (welding points) on the front layer 15 of the double-layer circuit board 10′ through two connection lines 41, 42, wherein, the negative potential of the driving device 40′ is connected to a first contact 151 through one connection line 41, and connected to a second circuit 12 of the back layer 16 through a via hole 17 on the first contact 151, and the second circuit 12 extends all the way to the rear end of the double-layer circuit board 10′. The positive potential of the driving device 40′ is connected to a second contact 152 on the double-layer circuit board 10′ through the other connection line 42 and connected to a first circuit 11 of the back layer 16 through a via hole 17 on the second contact 152, and the first circuit 11 also extends all the way to the rear end of the double-layer circuit board 10′. The above first circuit 11 and second circuit 12 are respectively connected to a third contact 153 and a fourth contact 154 on the front layer 15 through a via hole 17 at the rear end of the double-layer circuit board 10′. And the front layer 15 of the double-layer circuit board 10′ implements a detour circuit 13. The detour circuit 13 extends from the front end of the double-layer circuit board 10′ all the way to its rear end (in the figure, the detour circuit 13 is partially covered by the LED component 21, actually extending from the front end to the rear end). The via hole 17 on the double-layer circuit board 10′ in the figure is a known conductive technology, and in order to avoid crowded and complicated markings on the drawing, not all of them are marked, and the markings of other LED units, current limiting resistors and contacts are also the same.

The end of the double-layer circuit board 10′ is provided with a connector 30′ through which the third contact 153 (or the end of the second circuit 12 of the back layer 16) is connected to the end of the detour circuit 13 of the front layer 15. Therefore, the second circuit 12 of the back layer 16 is wound to the detour circuit 13 (path N) of the front layer 15, so that the end is connected to the double-layer circuit board 10′ for power supply.

The front layer 15 of the double-layer circuit board 10′ is connected in series with three LED components 21 and a current limiting resistor 22 to form an LED unit 20, and each LED unit 20 is connected in parallel to the first circuit 11 of positive potential and the detour circuit 13 of negative potential. For example, the positive potential of the LED unit 20 in the figure is connected to the fourth contact 154, and the fourth contact 154 is connected to the first circuit 11 through a via hole 17, and the negative potential of the LED unit 20 in the figure is connected to the detour circuit 13 of the front layer 15. Each LED unit 20 above is connected in parallel to the first circuit 11 of the positive potential powered from the head end, and the detour circuit 13 of the negative potential powered from the rear end. That is to say, the voltage-equalizing power distribution type white light LED strip light of the present invention is powered from both ends of the strip light.

In addition, due to the limited size of the production machine, in practical production, the above-mentioned strip light circuit board 10 or double-layer circuit board 10′ can take an appropriate length as the mass-produced strip light unit 100b, then use other connectors or welding methods to connect the required number of multiple strip light units 100b in series. For example, strip light circuit board 10 or double-layer circuit board 10′ is mass-produced strip light unit 100b with a length of 50 cm, one strip light unit 100b contains a total of 20 aforementioned LED sets 14, that is, the length of one LED set 14 is 2.5 cm. When the length of the strip light product is 10 meters, 20 strip light units 100b are required to connect in series.

In this embodiment, each one of the LED sets 14 is connected to form a cutting point 18. The front end of each LED set 14 has a cutting point 18 with a first contact 151 and a second contact 152 adjacent to its front end, and the rear end of each LED set 14 also has a cutting point 18 with a third contact 153 and a fourth contact 154 adjacent to its rear end, wherein the first contact 151 and the third contact 153 are connected to a second circuit 12 on the back through a via hole 17 respectively, the second contact 152 and the fourth contact 154 are also connected to the first circuit 11 on the back through a via hole 17 respectively. Therefore, the cutting point 18 where each two adjacent LED sets 14 are connected can be used as a cutting position. The last LED set 14 after cutting is used as the rear end of the strip light unit 100b, which can be used to assemble the connector 30′ or connect with the front end of another strip light unit 100b, thereby maintaining the structure of supplying power from both ends of the strip light to achieve the characteristics of equal voltage and uniform brightness of the entire strip light.

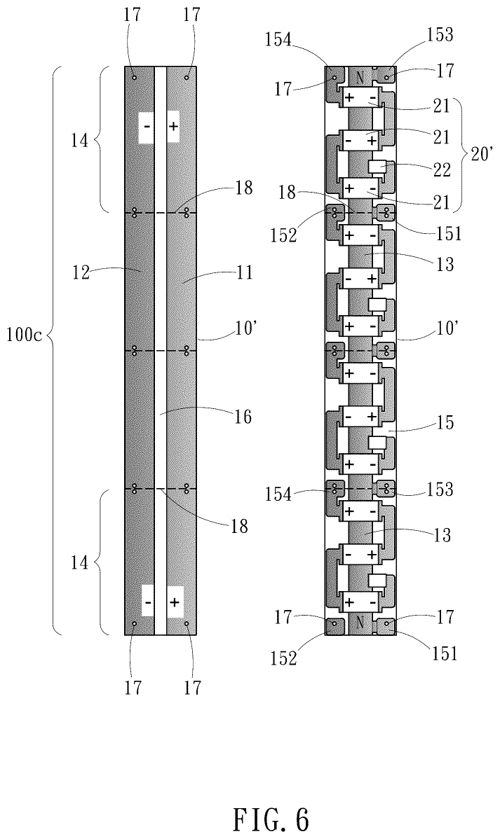

Referring to FIG. 6, in addition to connecting the detour circuit 13 of the strip light unit 100b to the second circuit 12 with a connector 30′ at the end, the detour circuit 13 of the strip light unit 100c can also be directly connected to the first contact 151 and the third contact 153 of each LED set 14 through its printed circuit. As mentioned above, the first contact 151 and the third contact 153 are connected to the second circuit 12 through the via holes 17, therefore, the detour circuit 13 is formed to be directly self-connected to the second circuit 12 at each line section of each LED set 14.

Therefore, the user is also allowed to select the appropriate cutting point 18 position (shown by the dotted line in the figure) to cut off the part that is too long to be discarded, according to the actual length needs. After being cut off, the structure of detour circuit 13 directly connected to the third contact 153 and connected to the second circuit 12 from the rear end of the strip light can be maintained, so as to achieve the effect of uniform voltage power supply of the whole strip light and uniform lighting of LED components. The strip light unit 100c shown in FIG. 6 can be connected in series at the end when the above-mentioned multiple strip light units 100b are connected in series. According to the embodiment in which the detour circuit 13 is directly connected to the first contact 151 and the third contact 153 of each LED set 14 through a printed circuit, the above-mentioned connector 30′ is not required.

### Example of Equal Voltage Type Wiring Type RGB Color Strip Light

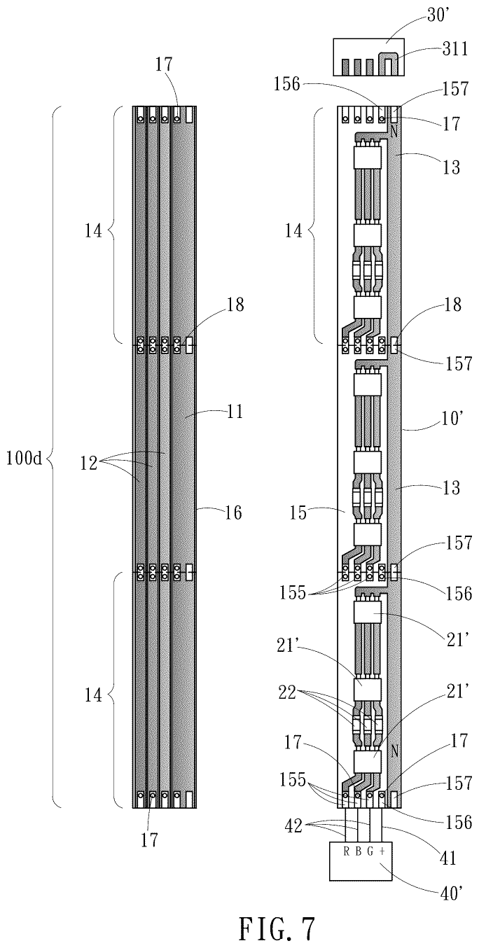

Referring to FIG. 7, it is a schematic diagram of the circuit layout of an embodiment of the voltage-equalizing wiring type RGB color strip light of the present invention. The strip light unit 100d in this embodiment is also described by taking the double-layer circuit board 10′ as an example, and the front layer and the back layer 16 of the double-layer circuit board 10′ are both represented by a top view angle.

This embodiment includes a driving device 40′ for driving the RGB color LED strip light. The positive potential of the driving device 40′ is connected to a first circuit 11 on the back layer 16 of the double-layer circuit board 10′ through a connection line 41, and the negative potential of the driving device 40′ is connected to three second circuits 12 on the back layer 16 of the double-layer circuit board 10′ through three connection lines 42, wherein the first circuit 11 and the three second circuits 12 on the back layer 16 of the double-layer circuit board 10′ are arranged in parallel, and extend from the front end of the double-layer circuit board 10′ all the way to its rear end. The front layer 15 of the double-layer circuit board 10′ implements a detour circuit 13. The detour circuit 13 also extends from the front end of the front layer of the double-layer circuit board 10′ all the way through each LED set 14 to its rear end. The front and rear ends of each LED set 14 on the front layer 15 respectively implement three fifth contacts 155 (soldering points) and one sixth contact 156 (soldering point) and a seventh contact 157. The three fifth contacts 155 are respectively connected to the three second circuits 12 on the back layer 16 through their respective via holes 17. The sixth contact 156 is also connected to the first circuit 11 on the back layer 16 through its via hole 17. And the seventh contact 157 is located on the detour circuit 13. Therefore, the driving device 40′ is connected to the three fifth contacts 155 and the one sixth contact 156, and is connected to the three second circuits 12 and the one first circuit 11 respectively.

Each LED set 14 of the double-layer circuit board 10′ implements one or more LED components 21′ and the RGB parts of the LED components 21′ are respectively connected in series with three current limiting resistors 22. An LED set 14 shown in FIG. 7 has three LED components 21′ connected in series. Each LED component 21′ is packaged by RGB three-color LED component (not shown). Then the RGB parts of three LED components 21′ and three current limiting resistors 22 are connected in series between the three fifth contacts 155 and the detour circuit 13.

The rear end of the double-layer circuit board 10′ is connected between the sixth contact 156 and the seventh contact 157 on the detour circuit 13 via a connector 30′, the first circuit 11 with a positive potential at the rear end of the double-layer circuit board 10′ is connected to the rear end of the detour circuit 13 through the via hole 17, the sixth contact 156 and the connector 30′ for power supply, and the R, G, B three-color negative potential lines maintain the voltage-equalizing wiring method powered by the front end of the double-layer circuit board 10′. Its technical principle is similar to the above-mentioned white light LED embodiment, and it can achieve the implementation of the voltage-equalizing wiring RGB color strip light of the present invention that supplies power from both ends of the strip light.

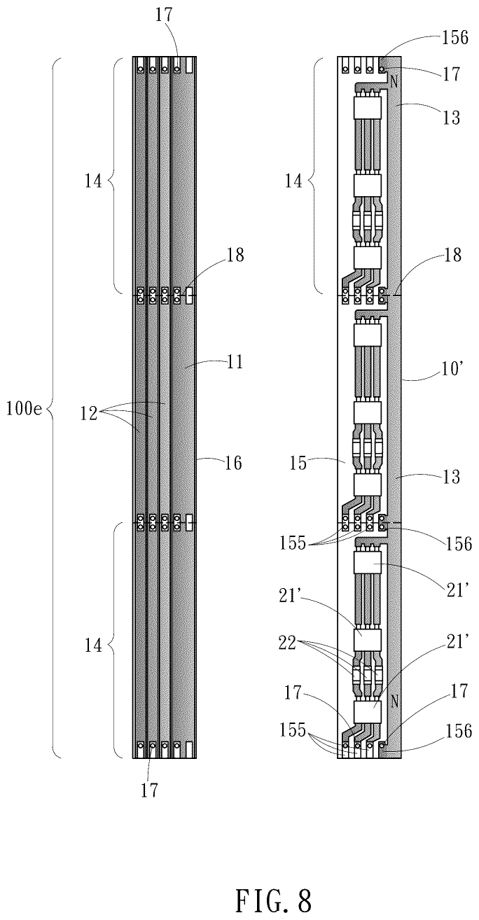

In the voltage equalizing wiring type RGB color strip light of this embodiment, the whole strip light can also be composed of several above-mentioned strip light units 100d connected in series, and referring to FIG. 8, it is also possible to use the endmost section of the strip light units 100e to connect the first circuit 11 with the detour circuit 13 in the double-layer circuit board 10′, instead of using the above-mentioned connector 30′, and the detour circuit 13 can also be directly connected to the sixth contact 156 of each LED set 14 through its printed circuit, as the above-mentioned sixth contact 156 is connected to the first circuit 11 through the via hole 17, thereby forming a structure in which the detour circuit 13 is directly connected to the first circuit 11 at the rear end of each LED set 14 without the use of the above-mentioned connector 30′. Moreover, the user is allowed to select the appropriate cutting point 18 to cut off according to the actual length requirements (as indicated by the scissors in FIG. 6). After being cut off, the rear end of the last LED set 14 still presents the structure in which the detour circuit 13 is directly connected to the sixth contact 156 and the first circuit 11 with positive potential, so as to maintain power supply from both ends and achieve the effect of uniform voltage and uniform brightness of the entire strip light.

The above embodiments have clearly proved that the present invention can be implemented in white light and color LED strip lights in a concrete and low-cost manner. The number of layers of the circuit board, the number of LED units and current resistors, the route, and the detour to the end power supply circuit mentioned in the examples are only for illustrating the preferred embodiments of the present invention, and do not limit the number of layers of the circuit board, the quantity and type of the LED units and current limiting resistors, and the path implementation.

Although a particular embodiment of the invention has been described in detail for purposes of illustration, various modifications and enhancements may be made without departing from the spirit and scope of the invention. Accordingly, the invention is not to be limited except as by the appended claims.

1. A voltage-equalizing power distribution type strip light, comprising a strip light circuit board, a plurality of LED units, a connector and a driving device, wherein:
said strip light circuit board is a long strip circuit board having a front end and an opposing rear end, said strip light circuit board comprising a first circuit, a second circuit and a detour circuit, said first circuit, said second circuit and said detour circuit extending from the front end of said strip light circuit board all the way to the rear end of said strip light circuit board;
said LED units are connected in parallel between said first circuit and said detour circuit, each said LED unit being composed of at least one LED component and a current limiting resistor connected in series, each said LED unit having one end thereof connected to said first circuit, and an opposite end thereof connected to said detour circuit;
said connector is assembled at the rear end of said strip light circuit board, so that said second circuit and said detour circuit at the rear end of said strip light circuit board are connected and conducted through said connector;
said driving device is an LED driver that supplies direct current, said driving device being connected to said second circuit at the front end of said strip light circuit board through a connection line and connected to said first circuit at the front end of said strip light circuit board through another connection line, and said second circuit being connected to said detour circuit through said connector at the rear end of said strip light circuit board to form a voltage-equalizing power distribution structure that supplies power from both ends of said strip light circuit board.

2. The voltage-equalizing power distribution type strip light as claimed in claim 1, wherein each said LED unit has a positive potential end thereof connected to said first circuit, and a negative potential end thereof connected to said detour circuit; or each said LED unit has a negative potential end thereof connected to said first circuit, and a positive end thereof connected to said detour circuit.

3. The voltage-equalizing power distribution type strip light as claimed in claim 2, wherein said strip light circuit board comprises a row of multiple LED sets connected together and arranged thereon and a cutting point provided between each adjacent said LED sets for cutting, each said LED set comprising at least one said LED unit; said first circuit, said second circuit and said detour circuit extend from the front end of said strip light circuit board through each said LED set until the rear end of said strip light circuit board; said connector is assembled at a rear end of the last said LED set of said strip light circuit board.

4. The voltage-equalizing power distribution type strip light as claimed in claim 3, wherein said connector is a plug-in connector, said plug-in connector comprising a plug conductor inside, said plug conductor being connected between said second circuit and said detour circuit extending to the rear end of the said strip light circuit board.

5. The voltage-equalizing power distribution type strip light as claimed in claim 3, wherein said connector is a welded conductor that is welded between said second circuit and said detour circuit that extend to the rear end of said strip light circuit board.

6. The voltage-equalizing power distribution type strip light as claimed in claim 3, wherein said second circuit extending to the rear end of said strip light circuit board is directly connected with said detour circuit to replace said connector.

7. A voltage-equalizing power distribution type strip light, comprising a double-layer circuit board, a plurality of LED units, a connector and a driving device, wherein:
said double-layer circuit board has a front end and an opposing rear end and comprises a front layer and a back layer;
the negative or positive potential of said driving device is connected to a first contact on said front layer, and then connected to a second circuit on said back layer through a via hole on said first contact, and the positive or negative potential of said driving device is connected to a second contact on said front layer, and then connected to a first circuit on said back layer through a via hole on said second contact, said first circuit and said second circuit respectively extending all the way to the rear end of said double-layer circuit board, said first circuit and said second circuit being respectively connected to a third contact and a fourth contact on said front layer through a respective via hole at the rear end of said double-layer circuit board, said double-layer circuit board further comprising a detour circuit arranged on said front layer and extending all the way from the front end of said double-layer circuit board to the rear end of said double-layer circuit board;
said connector is set on the rear end of said double-layer circuit board to connect the rear end of said third contact or said second circuit with the rear end of said detour circuit to change the way of connecting said second circuit of said back layer to said detour circuit on said front layer to the way of connecting the rear end of said second circuit to said double layer circuit board for power supply;
said front layer of said double-layer circuit board is connected in series with at least one LED components and a current limiting resistor to form each one said LED unit, each said LED unit being connected to said first circuit with positive potential and said detour circuit with negative potential, so that each said LED unit is connected in parallel to said first circuit which supplies positive potential power from the front end, and said second circuit which supplies negative potential power from the rear end.

8. The voltage-equalizing power distribution type strip light as claimed in claim 7, wherein each said LED unit has the positive potential terminal thereof connected to said fourth contact and said fourth contact is connected to said first circuit through a via hole thereof, and has negative potential terminal thereof connected to said detour circuit on said front layer through said current limiting resistor.

9. The voltage-equalizing power distribution type strip light as claimed in claim 7, wherein said double-layer circuit board comprises a plurality of LED sets connected in a row, each said LED set comprising at least one LED unit, each one of said LED sets being connected to form a cutting point so that the front end of each said LED set has a first contact and a second contact adjacent to the cutting point at the front end, and the rear end of each said LED set has a third contact and a fourth contact adjacent to the cutting point at the rear end, and said first contact and said third contact are respectively connected to said second circuit on said back layer through a respective via hole thereon, and said second contact and said fourth contact are respectively connected to said first circuit on said back layer through a respective via hole thereon.

10. The voltage-equalizing power distribution type strip light as claimed in claim 9, wherein said connector is connected between said third contact and said detour circuit at the rear end of the last said LED set of said double-layer circuit board.

11. The voltage-equalizing power distribution type strip light as claimed in claim 10, wherein said detour circuit is directly connected to the first contact and the third contact of each said LED set to replace said connector.

12. A voltage-equalizing power distribution type strip light, comprising a double-layer circuit board, a plurality of LED units, a connector and a driving device, wherein:
said double-layer circuit board has a front end and an opposing rear end and comprises a front layer and a back layer;
said driving device has the positive potential thereof connected to a first circuit on said back layer and at the front end of said double-layer circuit board, and the negative potential thereof connected to three second circuits on said back layer and at the front end of said double-layer circuit board, said first circuit and said three second circuits on said back layer respectively extending from the front end of said double-layer circuit board all the way to the rear end of said double-layer circuit board;
said front layer of said double-layer circuit board comprises a detour circuit, said detour circuit also extending from the front end of said double-layer circuit board all the way to the rear end of said double-layer circuit board, said front layer of said double-layer circuit board implementing three fifth contacts and one sixth contact at the front and rear ends of said double-layer circuit board respectively, said three fifth contacts being respectively connected to said three second circuits on said back layer through respective via holes thereon, said sixth contact being connected to said first circuit on said back layer through a via hole thereon;
at least one said LED unit on said double-layer circuit board is connected in series with three current limiting resistors, each said LED unit being packaged by a RGB three-color LED component, said LED units being connected in series with said three current limiting resistors, and connected between said three fifth contacts and said detour circuit;
the connection of said connector between said sixth contact and said detour circuit at the rear end of said double-layer circuit board forms that said first circuit at the rear end of said double-layer circuit board is connected to the rear end of said detour circuit for power supply.

13. The voltage-equalizing power distribution type strip light as claimed in claim 12, wherein said driving device is respectively connected to said three fifth contacts and said sixth contact, so as to be respectively connected to said three second circuits and said first circuit.

14. The voltage-equalizing power distribution type strip light as claimed in claim 12, wherein said double-layer circuit board comprises a plurality of LED sets connected in a row, and three said fifth contacts and one said sixth contact are respectively implemented on the front and rear ends of the front layer of each said LED set.

15. The voltage-equalizing power distribution type strip light as claimed in claim 12, wherein said sixth contact is directly connected to said detour circuit to replace said connector.

16. A wiring method for a voltage-equalizing power distribution type strip light, comprising the steps of: implementing a first circuit, a second circuit and a detour circuit on a strip light circuit board:
implementing a first circuit, a second circuit and a detour circuit on a strip light circuit board. said first circuit, said second circuit and said detour circuit extending from a front end of said strip light circuit board to an opposing rear end of said strip light circuit board respectively, said strip light circuit board comprising a plurality of LED units connected in parallel between said first circuit and said detour circuit; and
connecting said first circuit and said second circuit from the front end of said strip light circuit board through a plurality of connection lines of a driving device, and connecting a connector between said second circuit and said detour circuit from the rear end of said strip light circuit board through to form a structure that supplies power from both ends of said strip light circuit board.
